(19) United States
(12) Patent Application Publication
(10) Pub. No.: US 2010/0269629 A1
(43) Pub. Date: Oct. 28, 2010

(54) LOW FRICTION SLOTTED BEARING AND LINK APPARATUS

(75) Inventors: Samuel A. Nunn, Lake Forest, CA (US); Christopher J. Sommers, Yorba Linden, CA (US); Geoffrey Smith, Simi Valley, CA (US)

Correspondence Address: MICHAUD-Kinney Group LLP, 306 INDUSTRIAL PARK ROAD, SUITE 206, MIDDLETOWN, CT, 06457, US

(73) Assignee: Roller Bearing Company of America, Inc., Oxford, CT (US)

(21) Appl. No.: 12/766,348

(22) Filed: Apr. 23, 2010

Related U.S. Application Data
(60) Provisional application No. 61/172,366, filed on Apr. 24, 2009.

(51) Int. Cl. F16C 7/00; F16C 33/04

(52) U.S. Cl. 74/579 R; 384/276

(57) ABSTRACT

A low friction load slot bearing assembly has a ball and an outer race in which the ball is positioned. The outer race includes an inner engagement surface contoured to a shape complementary to an outer surface of the ball, a first slot located in a face of the outer race, a second slot located in the face of the outer race, and a lubricous liner disposed on the inner engagement surface and on surfaces defining the slots. The low friction aspect is imparted to the load slot bearing assembly via the lubricious liner. The ball slidably and rotatably engages the inner engagement surface of the outer race. A load slot bearing system includes a low friction load slot bearing assembly interconnecting two elements. A link apparatus includes a cylindrical member and two low friction load slot bearing assemblies located on or at opposing ends of the cylindrical member.

### CROSS REFERENCE TO RELATED APPLICATION

This application claims the benefit of U.S. Provisional Patent Application No. 61/172,366, filed on Apr. 24, 2009, the contents of which are incorporated herein by reference in their entirety.

### TECHNICAL FIELD

The present invention relates generally to bearing assemblies and, more particularly, to load slot bearings for use in link apparatuses.

### BACKGROUND

Spherical plain bearings typically comprise a ball positioned for rotational movement in an outer race. The outer race defines an inner surface contoured to receive and retain the ball therein. In one type of spherical plain bearing, the outer race is swaged around the spherical outer surface of the ball. These types of spherical plain bearings tend to provide suitable performance in low friction applications. In some cases, particularly those in which the ball and the outer race are each metallic, however, the outer race may be constructed with a slot to permit insertion of the ball. Such bearings are referred to as “load slot bearings.”

The manufacture of load slot bearings generally involves carburization processes to produce bearing elements having different hardnesses. Lapping of the outer race may also be employed to produce a bearing having the desired morphological surface characteristics for effective interaction between the outer race and the ball. Also, load slot bearings generally include provisions for grease lubrication to reduce the friction between the ball and the race. In load slot bearings in which grease lubrication is employed to reduce the friction, the bearing is subject to prescribed maintenance at scheduled intervals. Non-compliance with the prescribed maintenance or with the schedule of maintenance can increase bearing wear and can compromise the life of the bearing. In particular, improper maintenance such as insufficient lubrication can have an impact on bearing operation and promote galling, fretting, and/or other types of wear.

### SUMMARY

In one aspect, the present invention resides in a low friction load slot bearing assembly having a ball and an outer race in which the ball is positioned. The outer race includes an inner engagement surface contoured to a shape complementary to an outer surface of the ball, a first slot located in a face of the outer race, a second slot also located in the face of the outer race, and a lubricous liner disposed on the inner engagement surface and on surfaces defining the first and second slots. The low friction aspect is imparted to the load slot bearing assembly via the lubricious liner. The ball slidably and rotatably engages the inner engagement surface of the outer race.

In another aspect, the present invention resides in a load slot bearing system comprising a low friction load slot bearing assembly interconnecting two elements. The low friction load slot bearing assembly comprises a ball and an outer race positioned for slidable and rotatable movement on an outer surface of the ball. The outer race comprises an inner engagement surface contoured to a shape complementary to the outer surface of the ball, a first slot located in a face of the outer race, a second slot located in the face of the outer race and positioned opposite the first slot, and a liner disposed on the inner engagement surface and on a surface of each of the first slot and the second slot. With regard to the two elements interconnected with the low friction load slot bearing assembly, the first element may be a shaft or the like integral with or located in a bore extending through (or part way through) the ball, and the second element may be a housing or the like connected to the outer race. The liner provides a lubricious quality and the low friction aspect to the slidable and rotatable engagement of the ball with the inner engagement surface of the outer race. Preferably, the liner is made from a suitably lubricious material, such as, but not limited to, polytetrafluorotheylene.

In another aspect, the present invention resides in a link apparatus suitable for use in aircraft, aerospace, vehicular, and heavy equipment applications. The link apparatus comprises a cylindrical member and two low friction load slot bearing assemblies located on or at opposing ends of the cylindrical member. The load slot bearing assemblies each comprise a ball and an outer race in which the ball is positioned, the outer race being attached to a respective end of the cylindrical member. The outer race is defined by an inner engagement surface contoured to a shape complementary to an outer surface of the ball, at least one slot disposed in a face of the outer race, and a liner disposed on the inner engagement surface and on a surface of each of the slots. The liner is a lubricious material that allows the load slot bearing assembly to exhibit low friction characteristics. The ball slidably and rotatably engages the inner engagement surface.

### BRIEF DESCRIPTION OF THE DRAWINGS

FIG. 1 is a side sectional view of a low friction load slot bearing assembly, of the present invention.

FIG. 2 is a side sectional view of an outer race of the low friction load slot bearing assembly of FIG. 1.

FIG. 3 is a front view of the outer race of the low friction load slot bearing assembly of FIG. 2.

FIG. 4 is a partial sectional side view of a lubricious liner disposed on a surface of an outer race of the low friction load slot bearing assembly of FIG. 1.

FIG. 5 is a schematic representation of a system employing a low friction load slot bearing assembly interconnected with two elements for relative movement therebetween.

FIG. 6 is a side view of a link apparatus, of the present invention, employing the low friction load slot bearing assembly of FIG. 1.

FIG. 7 is a side view of an alternate embodiment of a link apparatus, of the present invention, employing the low friction load slot bearing assembly of FIG. 1.

### DETAILED DESCRIPTION

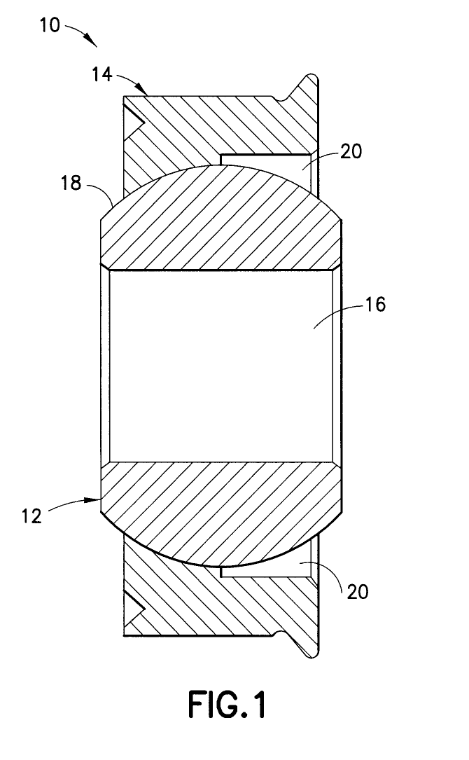

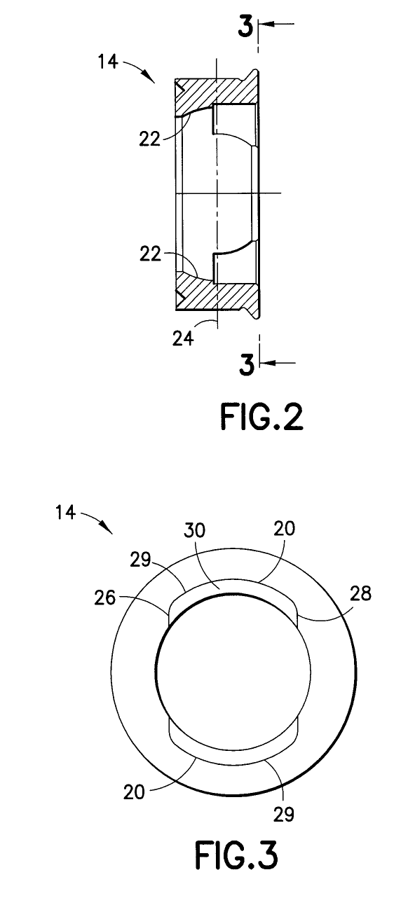

As is shown in FIGS. 1 and 2, a load slot bearing assembly of the present invention is designated generally by the reference number 10 and is hereinafter referred to as “bearing assembly 10.” Bearing assembly 10 includes a ball 12 positioned in an outer race 14. The ball 12 defines a bore 16 extending either part of the way or completely therethrough and is adapted to receive a portion of a shaft or other component therein. The present invention is not so limited, as the ball 12 may be integral with or form part of a shaft or other component. In the illustrated embodiment, the outer race 14 is a ring having an inner surface, a first portion of which is an inner engagement surface (designated by the reference number 22 in FIG. 2) contoured to a shape complementary to an outer surface 18 of the ball 12. A second portion of the inner surface of the outer race 14 defines two load slots 20. Each load slot 20 is arcuate and extends inwardly from one end of the outer race 14. While the outer race 14 has been shown and described as a ring, the present invention is not limited in this regard as the outer race can assume any practical shape or be part of another component, such as, for example a housing, without departing from the broader aspects of the invention.

During operation, the inner engagement surface of the outer race 14 engages and moves relative to the outer surface 18 of the ball 12. Suitable materials from which the ball 12 can be fabricated include, but are not limited to, metal, alloys such as steel, silicon nitride, silicon carbide, zirconium, and the like. Suitable materials from which the outer race 14 can be fabricated include, but are not limited to, ceramic, steel, aluminum, aluminum alloys, magnesium, magnesium alloys, and the like. The materials of either or both the ball 12 and the outer race 14 may be subjected to a high-temperature treatment process for hardening the surfaces thereof. In the alternative or additionally, the surfaces of the ball 12 and/or the outer race 14 may be subject to carburization.

As is shown in FIG. 3, each load slot 20 is located in a face of the outer race 14 and is defined by a first end face 26, a second end face 28, and a surface 30 connecting the first end face with the second end face. An outermost edge 29 of the surface 30 of each load slot 20 interfaces with the inner engagement surface 22. The interface of the outermost edge 29 of the surface 30 with the inner engagement surface 22 may be an angle or a radius. The distance between the first end face 26 and the second end face 28 is greater than the width W of the ball 12 to allow the ball to be inserted into the outer race 14 and rotated into an assembled position as shown in FIG. 1. As shown, the two load slots 20 are diametrically opposite each other in the face of the outer race 14.

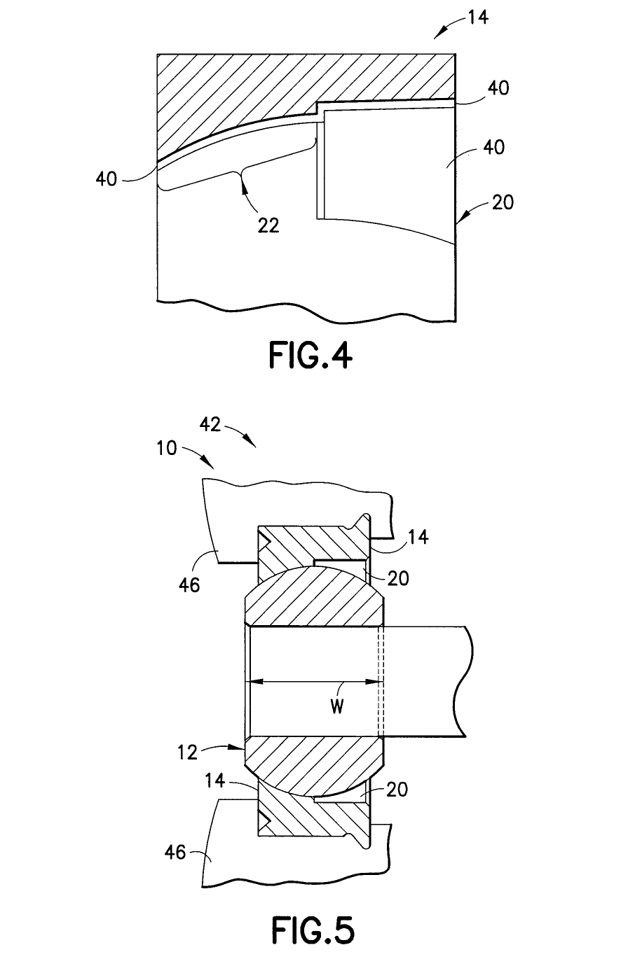

As is shown in FIG. 4, at least a portion of the inner engagement surface 22 comprises a liner 40 selected to facilitate low friction properties of the bearing assembly 10. The liner 40 is also disposed on the surface 30 of each load slot 20. The liner 40 comprises any suitable lubricious material deposited or otherwise disposed on the inner engagement surface 22 and the surface 30. Upon assembly of the ball 12 and the outer race 14, the outer surface 18 of the ball at least partially engages the liner 40. The lubricious qualities of the material from which the liner 40 is fabricated facilitate the movement of ball 12 in the outer race 14. Exemplary materials from which the liner 40 can be fabricated include, but are not limited to, polytetrafluoroethylene (PTFE) and the like. The present invention is not limited in this regard, however, as other materials may be used in the fabrication of the liner 40. Such materials include, but are not limited to, other solid lubricants such as glass-impregnated PTFE, polyacetals, polyether ether ketones, copper, bronze, oil-impregnated bronze, graphite, combinations of the foregoing materials, and the like.

As is shown in FIG. 5, a load slot bearing assembly system is designated by the reference number 42 and is hereinafter referred to as “system 42.” System 42 may be defined by employing one or more bearing assemblies 10 with the low friction qualities to accommodate movement between two or more moving elements or movement of one moving element relative to a stationary point. In such a system, the ball 12 is connected to a first element 44 such as a shaft or the like, and the outer race 14 is connected to, or forms part of, a second element 46 such as a housing or the like. Movement of the first element 44 relative to the second element 46 is accommodated by the bearing assembly 10 and facilitated by the liner 40 incorporated into the bearing assembly.

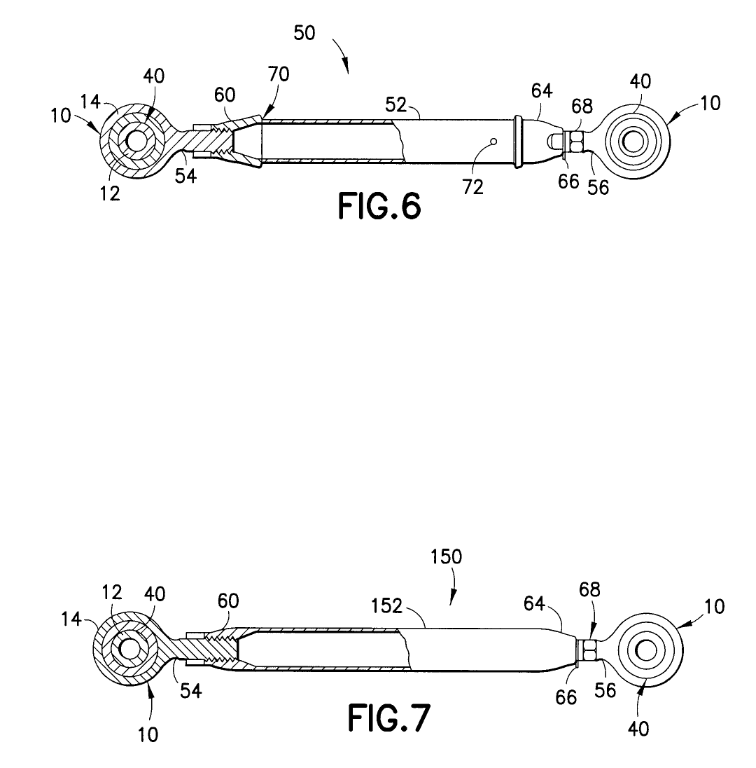

As is shown in FIGS. 6 and 7, the bearing assembly 10 may be used in connection with a link apparatus such as a control rod, steering link, tie rod, or the like that can be employed in aircraft, aerospace, heavy equipment, or vehicular applications. Use of the bearing assembly 10 is particularly adaptive to applications that typically involve metal-to-metal slot loader bearings such as aircraft oil cooler links that operate at temperatures at or below around 600 degrees F.

As is shown in FIG. 6, two bearing assemblies 10 are located on opposing ends of a link apparatus 50 comprising a cylindrical member 52. The outer race 14 of one bearing assembly 10 is integral with a first shaft 54 of the link apparatus 50, and the outer race of the other bearing assembly is integral with a second shaft 56 of the link apparatus. The ball 12 of each bearing assembly is attachable to any desired mechanism between which the link apparatus is providing mechanical communication. Each bearing assembly 10, as described above, includes the load slot 20 having the liner 40, thereby imparting low friction qualities to the bearing assemblies 10.

At a first end of the cylindrical member 52, the first shaft 54 of one bearing assembly 10 is threadedly received into a first socket 60 employing a left-handed thread. At a second end of the cylindrical member 52, the second shaft 56 of the other bearing assembly 10 is threadedly received into a second socket 64 employing a right-handed thread. Once the first shaft 54 and second shaft 56 are each threadedly received into the respective first socket 60 and second socket 64, locking devices 66 (e.g., lock washers) and nuts 68 may be used to secure the shafts to the sockets. Each of the first socket 60 and the second socket 64 is welded to the cylindrical member 52 at welds 70, which may extend circumferentially around a cross section of the cylindrical member 52. The cylindrical member 52 may include a vent hole 72.

In another embodiment of a link apparatus employing the bearing assembly 10 of the present invention, as is shown in FIG. 7, a link apparatus 150 comprises a cylindrical member 152. The bearing assemblies 10, the first shaft 54 and second shaft 56, and the first socket 60 and second socket 64 are the same or similar as described above. In the link apparatus 150, however, the first socket 60 and the second socket 64 are integral with the cylindrical member 152 to form a one-piece member connecting the bearing assemblies 10. The first socket 60 and the second socket 64 may be integrally formed with the cylindrical member 152, or they may be swaged onto the cylindrical member. The locking devices 66 and nuts 68 are the same or similar as in link apparatus 50.

In link apparatus 150 employing sockets that are integrally formed or swaged onto the cylindrical member 152, concentrated stresses are substantially less than those associated with link apparatuses in which the sockets are welded. From a performance perspective, link apparatus 150 also facilitates the reduction of fatigue stresses due to reverse loading. In any version of the link apparatus, the incorporation of the liner 40 having lubricious properties provides the low friction qualities and at least reduces the cost of maintaining the bearing assembly 10 by reducing or eliminating manual or automated lubrication of the bearing components.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A low friction load slot bearing assembly, comprising:
a ball; and
an outer race positioned on an outer surface of the ball, the outer race comprising,
an inner engagement surface contoured to a shape complementary to the outer surface of the ball,
a first slot located in a face of the outer race,
a second slot located in the face of the outer race and generally diametrically opposite the first slot,
a lubricous liner disposed on the inner engagement surface, on a surface of the first slot, and on a surface of the second slot; and
the ball being slidably and rotatably engaged with the inner engagement surface.

2. The low friction load slot bearing assembly of claim 1, wherein the first slot is defined by a first end face, a second end face, and the surface of the first slot connecting the first end face with the second end face, and
wherein the second slot is defined by a first end face, a second end face, and the surface of the second slot connecting the first end face with the second end face.

3. The low friction load slot bearing assembly of claim 1, wherein the lubricious liner comprises polytetrafluoroethylene.

4. A load slot bearing system, the system comprising:
a low friction load slot bearing assembly, comprising,
a ball, and
an outer race positioned on an outer surface of the ball, the outer race comprising,
an inner engagement surface contoured to a shape complementary to the outer surface of the ball,
a first slot located in a face of the outer race,
a second slot located in the face of the outer race and positioned opposite the first slot, and
a liner disposed on the inner engagement surface and on a surface of each of the first slot and the second slot,
the ball being slidably and rotatably engaged with the inner engagement surface;
a first element located in the bore of the ball and connected to the ball of the low friction load slot bearing assembly; and
a second element connected to the outer race of the low friction load slot bearing assembly;
wherein the liner provides a lubricious quality to the slidable and rotatable engagement of the ball with the inner engagement surface.

5. The load slot bearing system of claim 4, wherein the liner comprises polytetrafluoroethylene.

6. A link apparatus, comprising:
a cylindrical member;
a first load slot bearing assembly located at a first end of the cylindrical member; and
a second load slot bearing assembly located at an opposing end of the cylindrical member;
the first load slot bearing assembly and the second load slot bearing assembly each comprising,
a ball, and
an outer race positioned on an outer surface of the ball and attached to a respective end of the cylindrical member, the outer race comprising,
an inner engagement surface contoured to a shape complementary to the outer surface of the ball,
a first slot located in a face of the outer race,
a second slot located in the face of the outer race, and
a liner disposed on the inner engagement surface and on a surface of each of the first slot and the second slot,
the ball being slidably and rotatably engaged with the inner engagement surface.

7. The link apparatus of claim 6, wherein the outer race of each of the first load slot bearing assembly and the second load slot bearing assembly is integral with a shaft, each of the shafts being threadedly received in a socket on a respective end of the cylindrical member.

8. The link apparatus of claim 6, wherein each of the sockets is welded to the cylindrical member.

9. The link apparatus of claim 6, wherein each of the sockets is swaged to the cylindrical member.

10. The link apparatus of claim 6, wherein the liner comprises polytetrafluoroethylene.
